(19) United States
(12) Patent Application Publication
(10) Pub. No.: US 2012/0138673 A1
(43) Pub. Date: Jun. 7, 2012

(54) Method and Device for Recognition of Objects Having a Confusingly Similar Appearance

(76) Inventors: Gerd Eckert, Hamburg (DE); Oliver Franz, Hamburg (DE); Kay Körner, Hamburg (DE); Martin Stranzinger, Hamburg (DE); Christian Taesler, Buxtehude (DE); Thomas Uschkureit, (US); Daniel Voss, Hamburg (DE); Christian Ziegmann, Ahrensburg (DE)

(21) Appl. No.: 13/197,204

(22) Filed: Aug. 3, 2011

Related U.S. Application Data
(60) Provisional application No. 61/370,209, filed on Aug. 3, 2010.

(30) Foreign Application Priority Data
Aug. 3, 2010 (DE) 10 2010 033 181.3

(51) Int. Cl. G06K 5/00; G06F 17/00

(52) U.S. Cl. 235/375

(57) ABSTRACT

Objects having a confusingly similar appearance, e.g., laboratory vessels, are provided with a random or pseudo-random pattern. The pattern can be provided during the manufacture of the object and is formed in a part or on a surface of the object, By way of example, the pattern can be a two-dimensional black/white pattern, an N-dimensional color or gray scale pattern, a one-dimensional emission spectrum with peaks of variable heights or a two-dimensional excitation spectrum with peaks of variable height. At least one section of the pattern is identified, for example, by a photographed imagine of the pattern. The so-identified section is then electronically saved and labeled as a representative of the pattern. The object is then capable of automated recognition by matching the pattern with the previously saved representative section of the identified pattern, Also disclosed is a device configured to translate the identified pattern into an electronic code and then recognize the object by the saved code.

The present invention relates to a method for recognition of a confusable object.

In order to identify confusable objects, it has long been known to label them. As is generally known, this can occur through signs or labels. For example, modern systems also provide barcodes—i.e. labelings that are visible but that cannot be deciphered with human understanding, but rather need to be read into a computer using scanners and identified there.

In particular, the disadvantage of known labeling methods is the attachment of the specific labeling. Whether abstract barcode or a more concrete labeling, an affixing or attaching for example using labels or printing is required. This is at least an additional process step, but can also involve the risk of accidental removal and loss

The object of the present invention is to create a method for recognition of a confusable object, which makes the physical labeling of the object unnecessary.

This object is solved by a method with the characteristics of claim 1. Preferred embodiments are specified in the dependent claims.

According to the invention, the method for recognition of a confusable object has the following steps (wherein steps d) and f) are optional but particularly preferred according to the invention, for example in order to complement representatives through a shorter and/or more easily readable and/or more easily electronically processed labeling):

a) Providing the object with a random or pseudo-random pattern;

b) Automatedly identifying at least one section of the pattern;

c) Electronically saving a representative of the pattern;

d) Electronically assigning a labeling to a saved representative;

e) Automatedly recognizing at least one section of the pattern; and

f) Providing an output of the identifier, which is assigned to its representative.

Step a) (providing the object with a random or pseudo-random pattern) is preferably performed during the production of the object. If the object concerns, for example, laboratory receptacles that are identical from the outside and thus confusable but are filled with liquid samples that must be differentiated from one another, the step a) according to the invention can consist of adding particles during the injection molding of the laboratory receptacles. They distribute themselves in the plastic randomly and thus form a random pattern. For example, opaque particles in transparent plastic make the pattern translucently identifiable or suitable brightness- or color-contrasting particles can be identified on the surface of the plastic as a random pattern.

Producing the pattern according to the invention through particle admixture is only one example of a pattern according to the invention through spatial distribution of optical intensities—by means of optical intensities as a function of spatial coordinates. However, for example, a spectral distribution of optical intensities for the formation of the pattern is also possible according to the invention—by means of optical intensities as a function of spectral coordinates (more detail to follow below).

According to the invention, objects can also be for example in the laboratory field objects for the transfer of samples, that is for example exchangeable pipette tips and in general so-called consumables—i.e. objects that must be replaced regularly. Also in the case of these objects, the identification according to the invention can also advantageously serve to facilitate, automate and/or to systematize the reordering of the objects and/or the identification for warehousing and/or inventory.

Steps b) through d) can serve for the initial identification of the confusable object: for example, at least one section of the pattern can be recorded, for example photographed, using a suitable image recognition device, for example a CCD camera. If it concerns for example a pattern of mainly same-sized, mainly spherical particles in a transparent plastic, a CCD camera can record a picture of the pattern and determine using suitable software whether (if for example the pictured particles are approximately the same size as the pixels of the picture) a pixel shows a particle (“1” in a two-dimensional matrix representing this picture) or not (“0” in this matrix). At least, for example, this matrix is then saved as a representative of the identified pattern in step c). For actual “labeling” of the object so far identified by the pattern, an identifier can especially preferably be assigned to the representative and be stored together with the representative (step d)). The selection and assignment can take place in a correspondingly set-up reading/playback device, which for this purpose has a suitable control panel such as e.g. a keyboard, by a user (randomly) or also automatically by an set-up program. The identifier can be an alphanumeric character string but can also contain special characters and/or symbols. The identifier can also be electronically savable information or a file.

The object once identified in this manner and so-to-speak virtually labeled (through the representative and if applicable identifier) can now be recognized at any time: for example by means of the previously mentioned reading/playback device (that can now also have a suitable display for a partial purpose in this connection), at least the section of the pattern, which was identified in step b) is first automatedly recognized for example using the CCD camera of the reading/playback device (step e)). The scanner then shows the identifier on the mentioned display (and/or outputs them for example to a computer for further processing; step f)), which was assigned to the saved representative of the recognized pattern (in step d))—which was given as a so-to-speak name to this although confusable but specific individual object (without labeling it physically).

The method according to the invention is thus based on the fact that a confusable object is provided with a randomly distributed pattern and is thereby uniquely identified. This randomly distributed pattern can, for example, be

a two-dimensional black/white pattern;

an N-dimensional color—or gray-scale pattern;

a one-dimensional emission spectrum with peaks of variable height; or

a two-dimensional excitation emission spectrum with peaks of variable height.

Generally, the pattern consists of an n-dimensional (n=1 . . . N) random distribution of a measureable physical size θ=f (φₓ; φ_{y}; . . . ), wherein the dimension space is spanned by one or more dimensions φ orthogonal to the measurable physical size. θ can hereby be for example brightness or absorption and φ for example spatial coordinates, time or wavelength.

Based on a short, already briefly indicated example, it should be demonstrated that randomly distributed patterns (or corresponding pseudo-randomly generated patterns) are suitable for being used as a unique identification characteristic. In this example, the pattern is formed by a distribution of particles on a two-dimensional plane. The particles can form for example darkened points in front of a light background. The thereby created light/dark pattern can be recorded using a CCD camera. For simplification, it is also assumed that the particles are smaller than the pixel resolution of the camera and that each particle darkens exactly one pixel.

An inexpensive, commercially available CCD camera with CCIR-TV resolution has a resolution of approximately 628×582 pixels. In order to be able to balance positioning inaccuracies, it is assumed that approximately one-third of the image height or respectively image width should remain as free margin. Thus, a resolution of 400×400 pixels is available for the pattern to be identified, that is each individual particle is recorded at one out of a total of 160,000 different positions.

Now, if there are for example only 10 particles on the surface of the pattern, then each particle can be located on one of the different positions, i.e. there are already approximately 10⁴⁵ combinations in this very simplified example. Even with 100×100 pixels and 10 therein-pictured particles, it would already be 10³³ combinations. However, even in this example, the coding for all practical purposes can be classified as unique. However, a sufficient redundancy should advantageously be taken into consideration in order to enable failure-free recognition using suitable software, for example when particles of the pattern are incorrectly identified, for example because of scratches. In order to increase redundancy, the pattern should thus preferably contain more than 20 particles or preferably contain particles that cover several pixels.

Preferably, the pattern for step b) and step e) is optically visible or can be made optically visible or measurable. For immediate visibility, these two steps were already described using a CCD camera, which can serve for identification and recognition For example in the case of applications, in which a pattern which is visible (also to the human eye) is disruptive because it has a “dirty” or disorderly effect, the pattern can also be made visible or measureable according to the invention (for example by means of suitable illumination or other excitation of correspondingly sensitive particles; for example via radioactivity, phosphorescence or fluorescence). Examples of this are not only patterns that are formed from spatial distribution but also patterns that are formed from spectral distribution of optical intensities. In the case of spatial distribution, the intensity θ is a function of spatial coordinates. An example is thus a two-dimensional gray-scale pattern that one obtains as a picture of a two-dimensional distribution of particles for example using a camera. In the case of spectral distribution, the intensity is a function of spectral coordinates. Typical cases are for example one-dimensional absorption or fluorescence spectra. Other examples are two-dimensional total fluorescence spectra, in which one spectral coordinate represents the excitation wavelength, and the other spectral coordinate represents the emission wavelength (see for example: F. H. Frimmel, M. U. Kumke. Optische Parameter zur Stoffcharakterisierung vom Trinkwasser bis zum Abwasser (Optical Parameters for Substance Characterization from Drinking Water to Waste Water). University of Potsdam, 1998).

For example in the spectral distribution of optical intensities as the pattern according to the invention, the composition of its substance can vary at least section-wise for example through a dissolved substance in a random or at least pseudo-random manner in the object to be identified and thus form the pattern according to the invention.

However, an intensity distribution on a magnetizeable medium, i.e. e.g. a binary code on a magnetic data carrier, i.e. a “measurable” pattern of spatially distributed magnetized cells on a magnetic strip, is also conceivable for example according to the invention.

A visible or to-be-made-visible pattern according to the invention preferably consists of particles, which are incorporated into the confusable object at least in a certain, preferably marked, part. The particles preferably have a certain design. This has the advantage that the identification in step b) and the recognition in step e) of the pattern can be electronically checked and/or corrected by matching the identified pattern with the determined design. For example, the particles are fibers of a certain length and/or certain diameter, spheres of a certain diameter or disks of a certain thickness and contour. In particular, particles according to the invention of a certain design have at least one dimension (for example length or diameter) with a certain minimum size and maximum size (tolerance field width).

According to the invention, a confusable object, for example a laboratory receptacle or a holder for laboratory receptacles such as a rack or tray or a removable block, is also provided with a random or pseudo-random pattern and thus particularly suitable for performing the method according to the invention.

According to the invention, another aspect is a device for the recognition of a confusable object such as the reading/playback device described above in the description of the method. According to the invention, this device has a positioning device, which is adapted to reproducibly set to position an object of a certain form, as well as a pattern identification device, which is adapted to identify a pattern in a certain part of the object, as described for example using a CCD camera. It can be ensured by the positioning device that the pattern identification device is always aligned with the part of the object in which the pattern is located if such an object was inserted into the positioning device. The positioning device can have for example form-fitting, complementary parts of the outer contour of the object, at which the positioning device is pointed. This enables fast and safe positioning.

Furthermore, the device has an electronic data processing device and a memory. They are adapted to translate the identified pattern into an electronic code or representative and to save it together with an identifier assigned to the code and/or to compare it with code saved in the memory and to output the saved identifier assigned to the save code in the case of match within a certain tolerance. Thus, this device outputs an identifier to an initially identified object by means of the electronic data-processing device and/or outputs this identifier of a recognized object. The output can take place by means of a display device. The identifier can be input by a user using a display device. The electronic data-processing device can be programmable such that it automatically assigns the identifier in a programmable manner.

The invention and thereby achieved advantages will be described further in an exemplary embodiment based on the attached figure.

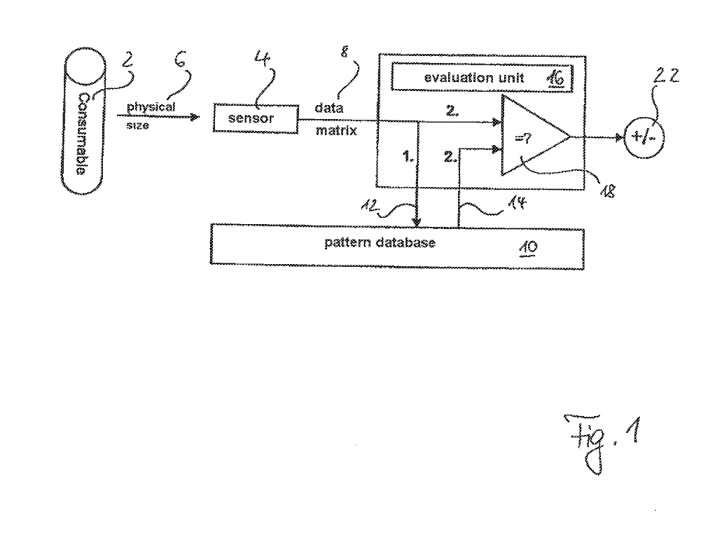

FIG. 1 shows a schematic flow chart of the method according to the invention and

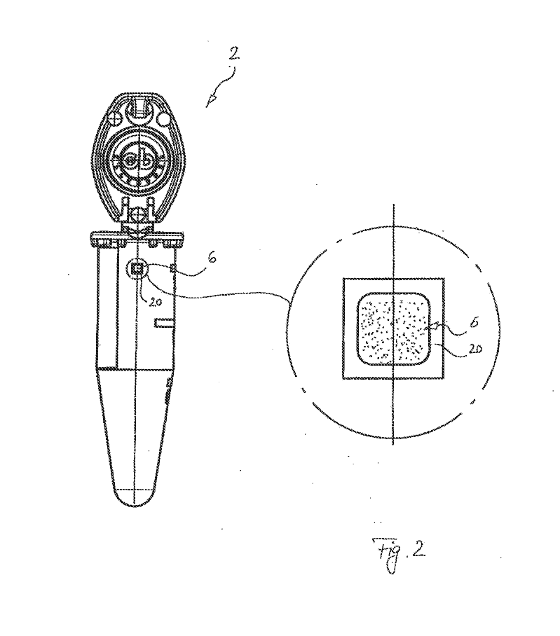

FIG. 2 shows a laboratory receptacle provided according to the invention in a front view with an enlarged section of the front side.

A laboratory receptacle 2 confusable due to its outer design, a so-called “consumable,” as also shown in FIG. 2, is identified, that is “labeled”, as per FIG. 1 within a superordinate application (not shown), namely an automated pipetting process. This process for identification is performed using a reading/playback device (not shown). The reading/playback device can be part of the device for performing the superordinate application.

The reading/playback device has a sensor 4, which is able to translate a physical pattern 6 (also see FIG. 2) into a data matrix 8, as well as a pattern database 10, into which the data matrices can be saved 12 or read out 14, as well as an evaluation unit 16, which can compare 18 a data matrix 8 supplied by the sensor 4 with the data matrix 14 saved in the pattern database 10.

The reading/playback device has two operating modes, namely a calibrating mode and a recognition mode. In the calibrating mode, a certain consumable 2 with a known content, which is provided with a random pattern 6 created according to certain rules like all similar consumables, is introduced into the reading/playback device. The data matrix 8 corresponding to its individual pattern 6 is saved 12 in the pattern database 10.

In the recognition mode, a consumable 2 with (now currently) unknown contents is introduced to the reading/playback device. The data matrix 8 corresponding with the pattern is compared 18 with the data matrices saved in the pattern database 10. If the data matrices match, the evaluation unit identifies the consumable as already identified (“labeled”).

The described evaluation unit of the reading/playback device performs the following steps for each pattern check successively: an alignment and the pattern comparison.

The upstream alignment is useful for compensating for shifts, rotations and deformations of the pattern between calibration and recognition, which can be caused for example by positioning inaccuracies of the consumable in a positioning device of the reading/playback device, but also by temperature-related stretching or compressions or by changes in the distance between the consumable and the sensor.

In order to be able to perform the alignment with the least possible effort, the random pattern 6 of the same types of consumable 2 is always equipped with the same calibration geometry 20. In FIG. 2, this is a rectangle 20 that surrounds the pattern 6. Thus, the surrounding rectangle 20 can be identified by means of an algorithm for pattern identification and the therein contained pattern 6 can be aligned and deskewed with the rectangle 20.

After the alignment, the pattern 6 read by sensor 4 is compared with the patterns from the pattern database 10. The comparison can take place by means of an image matching algorithm for example of the normalized grayscale correlation (NGC), a correlation of the Fourier transforms of the patterns or also with the help of neuronal networks. Based on the level of match determined in this manner, the evaluation unit 16 finally decides whether or not 22 the pattern 6 read by sensor 4 is recognized as identical to the current comparison pattern from the pattern database 10.

1. A method for recognition of a confusable object with the steps:
a) Providing the object with a random or pseudo-random pattern, which is unique with a certain probability;
b) Automatedley identifying at least one section of the pattern;
c) Electronically saving a representative;
e) Automatedly recognizing at least that section of the pattern.

2. The method according to the previous claim, additionally with the steps in the order according to the lettering:
d) Electronically assigning an identifier to the saved representative;
f) providing an output of the identifier, which is assigned to its representative.

3. The method according to one of the previous claims, characterized in that the pattern is visible or can be made visible or measurable,

4. The method according to one of the previous claims, characterized in that the pattern of incorporated particles is formed in a translucent part and/or on a surface of the object.

5. The method according to the previous claim, characterized in that the particles have a certain design, in particular for at least one dimension a certain tolerance field width.

6. The method according to the previous claim, characterized in that the panicles are fibers, which have in particular a certain diameter and/or a certain length.

7. The method according to one of the previous claims, characterized in that the pattern is a spatial or spectral distribution of electromagnetic intensities or an intensity distribution on a magnetizable medium.

8. The method according to one of the previous claims, characterized in that the object is a laboratory receptacle or a holder for laboratory receptacles, in particular a rack, track or removable block.

9. The method according to one of the previous claims, characterized in that the identifier has a series of electronically representable characters.

10. The method according to one of the previous claims, characterized in that at least one of the steps b) through f) is executed by means of a reading/playback device with an electronic data-processing and also an image-detecting device and/or by means of a computer.

11. The method according to one of the previous claims, characterized in that step a) is executed during the production, in particular during the injection molding, of the object.

12. An object, characterized in that it is equipped with a random or pseudo-random pattern, in particular for performing the method according to one of the previous claims.

13. The object according to the previous claim, characterized in that the pattern is visible or can be made visible or measurable.

14. The object according to one of the two previous claims, characterized in that the pattern of incorporated particles is formed in a translucent part and/or on a surface of the object.

15. The object according to the previous claim, characterized in that the particles have a certain design, in particular for at least one dimension a certain tolerance field width.

16. The object according to the previous claim, characterized in that the particles are fibers, which have in particular a certain diameter and/or a certain length.

17. The object according to one of the five previous claims, characterized in that the pattern is a spatial or spectral distribution of electromagnetic intensities or an intensity distribution on a magnetizable medium.

18. A device for recognition of a confusable object, characterized by
a positioning device, which is set up to reproducibly position an object of a certain form and by
a pattern identification device, which is set up to identify a pattern in a certain part of the object and by
an electronic data processing device with a memory, which is set up to translate the identified pattern into an electronic code (representative) and to save it together with an identifier assigned to the code, and/or to compare it with codes saved in the memory and in the case of a match within a certain tolerance to output the identifier assigned to the saved code.

19. The device according to the previous claim, characterized by an input device, which is adapted for the input of the identifier by a user and/or an automatic, in particular programmed, assignment of the identifier.

20. The device according to one of the two previous claims, characterized by a display device, which is adapted for the display of the identifier visible for a user.

21. The device according to one of the three previous claims, characterized by a processing device, which is adapted to automatically perform at least one further process step depending on the identifier.
